(19) United States
(12) Patent Application Publication
(10) Pub. No.: US 2008/0057243 A1
(43) Pub. Date: Mar. 6, 2008

(54) Container

(76) Inventors: Kurt Oberhofer, Wilhelmsfeld (DE); Timm Oberhofer, Wilhelmsfeld (DE)

Correspondence Address: Thomas M. Galgano;Galgano & Associates, 20 W. Park Avenue Suite 204, Long Beach, NY, 11561, US

(21) Appl. No.: 11/663,240

(22) PCT Filed: Sep. 16, 2005
(86) PCT No.: PCT/EP05/09974

§ 371 Date: Mar. 19, 2007

(30) Foreign Application Priority Data
Sep. 17, 2004 (EP) 04022135.0

(51) Int. Cl. B29D 22/00; B28B 1/14

(52) U.S. Cl. 428/35.7; 264/299

(57) ABSTRACT

The invention relates to a container which has a sealed, external diffusion barrier layer which covers the whole surface and which is made of a film material, and a continuous supporting plastic layer which forms the top surface. The plastic layer does not require use of a plastic material having a superior barrier effect against oxygen and/or carbon dioxide diffusion.

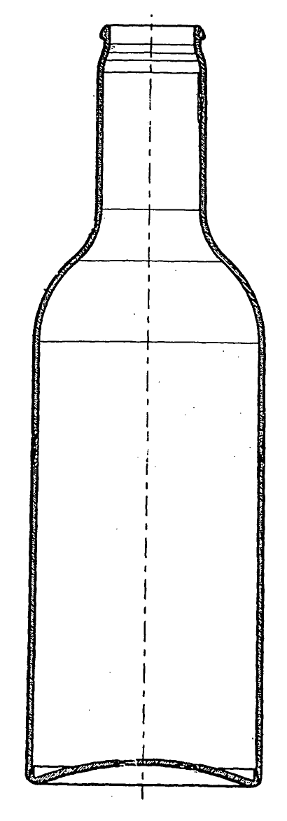

The invention relates to a dimensionally stable and impervious container. In particular, it relates to a container for packaging a fluid, such as cans and beverage bottles.

Beverage bottles of various materials are known. Glass beverage bottles are widely used. Aside from its transparency to light, glass is impervious to practically all external influences. Recycling of glass bottles, whether by reuse after thorough cleaning or by remelting, is possible without problems. The arguments against the use of glass bottles for beverages are their somewhat high production costs, their transparency to light and their heavy weight.

Beverage bottles of glass are being increasingly replaced by plastic bottles. These can be manufactured inexpensively by plastic injection-molding techniques or plastic blow-molding techniques, and they have light weight. In order to achieve a good barrier effect against diffusion of oxygen and carbon dioxide, however, it is necessary to use special, relatively expensive plastic materials such as polyethylene terephthalate (PET). Despite this, the barrier effect of a plastic bottle against the diffusion of oxygen and carbon dioxide continues to lag behind that of a glass bottle. This has a detrimental influence on the shelf life and taste of the beverage.

Aluminum bottles are coming into use, especially in the market segment of high-quality beverages. Their production costs are much higher than those of a plastic bottle. Aluminum screens out visible and ultraviolet light and has an excellent barrier effect against the diffusion of oxygen and carbon dioxide.

Elemental aluminum is also absolutely compatible with food products. However, the manufacture of one hundred percent pure aluminum is technically not possible. Aluminum always contains a minimum content of heavy metal, which becomes problematic for direct contact with food products. For this reason, beverage bottles of aluminum are usually lacquered on the inside. This lacquering is expensive.

From U.S. Pat. No. 4,601,926 A it is known how to equip a plastic bottle with a barrier label. The label is composed of aluminum foil with a layer of heat-activated adhesive having high barrier effect. The bottle is manufactured in the blow-molding technique. The label is laid in the blow mold and heated to activation temperature, and the bottle body is molded thereon. The label encircles the middle cylindrical part of the bottle body.

From British Patent 2205295 A it is also known how to equip a plastic bottle with an adhesively bonded barrier label. Plastic bottles with barrier layers are also known from German Patents 2111880 A1 and 1923860 A1.

European Patent 0786414 A relates to a container of composite material, manufactured by placing an outer container of paper in a metal mold and molding an inner container of plastic thereon.

The object of the invention is to provide a dimensionally stable, impervious container that can be manufactured inexpensively and that combines the advantageous characteristics of an aluminum container and a plastic container.

This object is achieved by a container having a seal-bonded, full-surface external diffusion barrier layer, which is composed of film material, and a plastic support layer continuously forming the internal surface.

The external diffusion barrier layer of film material ensures a good barrier effect against the diffusion of oxygen and carbon dioxide. Because of the small film thickness of at most 0.5 mm, the material costs for the diffusion barrier layer are low. For the plastic support layer forming the internal surface, there is needed a plastic material that is compatible with food products, although it is not required to have a superior barrier effect against the diffusion of oxygen or carbon dioxide. Success can therefore be achieved with comparatively inexpensive plastics, such as polyethylene (PE) or polypropylene (PP). The plastic support layer can be manufactured inexpensively by injection molding or blow molding.

In a preferred embodiment, the film material of the diffusion barrier layer is plastic film, especially polyethylene film (PE film) or polypropylene film (PP film), laminated with aluminum or an aluminum alloy. The aluminum or aluminum alloy layer of the film screens out visible and ultraviolet light and ensures an excellent barrier effect against the diffusion of oxygen and carbon dioxide. The plastic layer of the film prevents direct contact of the container content with the aluminum. The external appearance of the container can be that of a high-quality aluminum container.

In an alternative preferred embodiment, the film material of the diffusion barrier layer is ethyl vinyl alcohol film (EVOH film). This material has a very good barrier effect against diffusion of oxygen and carbon dioxide. In order to impart the external appearance of a high-quality aluminum container to the container, the EVOH film can be coated with aluminum or an aluminum alloy by vapor deposition.

In a preferred embodiment, the aluminum or aluminum alloy side of the diffusion barrier layer is the outside of the container. Such a container then has the unadulterated appearance of a high-quality aluminum container.

Nevertheless, in an alternatively preferred embodiment, the aluminum or aluminum alloy side of the diffusion barrier layer can be provided with a cover layer of plastic, which functions for protection and/or for the purposes of optical styling. The cover layer can extend over the entire surface or part of the surface, have one or more layers, and be transparent or opaque. A transparent cover layer preserves the appearance of a high-quality aluminum container.

A preferred method for manufacturing the container consists in placing the film material forming the diffusion barrier layer in the form of a full surface in a molding die of the plastic molding technique, loading the molding die with plastic in moldable, sealable condition, and removing the container provided with the seal-bonded diffusion barrier layer from the molding die after solidification of the plastic.

In a preferred embodiment, the film material is loaded into the molding die with the aluminum or aluminum alloy layer on the outside.

In a preferred embodiment, the film material is loaded into the molding die in one piece or in several pieces overlapping at the joints.

The method for manufacturing the inventive container can be accomplished both with a molding die of the plastic injection-molding technique and with a molding die of the plastic blow-molding technique. The plastic used for casting or blowing is not required to have any superior barrier effect against the diffusion of oxygen and/or carbon dioxide. The plastic must be capable of being seal-bonded to the plastic on the inside of the film material of which the diffusion barrier layer is composed. It may be the same plastic, such as polyethylene (PE) or polypropylene (PP).

A plastic that is known to have a superior barrier effect against the diffusion of oxygen and/or carbon dioxide is polyethylene terephthalate (PET). The invention dispenses with PET, however, since the barrier effect against diffusion of oxygen and/or carbon dioxide is provided by the diffusion barrier layer of film material.

The plastic of choice for the present invention is polypropylene (PP). PP is highly suitable for injection molding of thin-walled parts, is compatible with food products, does not have a superior barrier effect against the diffusion of oxygen and/or carbon dioxide, and therefore is inexpensive. An alternative highly suitable plastic is polyethylene (PE).

### EXAMPLE 1

In a molding die of the plastic injection-molding technique or plastic blow-molding technique used for the manufacture of a bottle, there is loaded a single cut-to-size film section. The film is a polypropylene composite film coated with aluminum. It has a core of micro-foamed polypropylene, which is laminated with aluminum. The cut-to-size section is loaded into the molding die in such a way that it covers the full surface with overlapping at the joints, with the aluminum layer facing outward. The molding die is filled out with hot, molten polypropylene by injection or blowing, and the finished bottle is removed after the plastic has solidified. The bottle has a seal-bonded, full-surface external layer of film-thick aluminum.

### EXAMPLE 2

Same as Example 1, with the difference that the cut-to-size sections of foil are loaded in several pieces into the molding die in such a way that they cover the full surface with overlapping at the joints.

### EXAMPLE 3

Same as Example 1 or 2, with the difference that the aluminum layer of the polypropylene film coated with aluminum is coated on the entire external surface with film-thick polypropylene. The film material of the diffusion barrier layer is a three-level composite film with one level of aluminum in the middle and levels of polypropylene on the inside and outside.

### EXAMPLE 4

Same as Example 1 or 2, with the difference that the cut-to-size sections of film are composed of ethyl vinyl alcohol film (EVOH film) coated with aluminum by vapor deposition, and are loaded into the molding die with the aluminum side facing outward.

### EXAMPLE 5

Same as one of Examples 1 to 4, with the difference that the bottle is manufactured in two parts, or in other words a body with neck, shoulder and belly as one part and a bottom as the other part. The body and bottom are heat-sealed to one another.

The single illustration shows the bottle according to Example 5 in longitudinal section.

1. A dimensionally stable and impervious container having an external surface and an internal surface comprising a seal-bonded, full-surface external diffusion barrier layer, which is composed of film material, and a plastic support layer continuously forming said internal surface of said container.

2. A container according to claim 1, wherein said film material of the diffusion barrier layer is plastic film.

3. A container according to claim 1, wherein said film material of said diffusion barrier layer is ethylene vinyl alcohol film.

4. A container according to claim 3, wherein said ethylene vinyl alcohol film is coated on one side by vapor deposition with an aluminum containing material.

5. A container according to claim 4 wherein said coated side of said diffusion barrier layer defines said external surface of said container.

6. A container according to claim 4 wherein said coated side of said diffusion barrier layer is provided with a cover layer of plastic.

7. A container according to claim 6, wherein said cover layer extends over the entire surface of said coated side.

8. A container according to claim 6, wherein said cover layer has one ply.

9. A container according to claim 6, wherein said cover layer has multiple plies.

10. A container according to claim 6, wherein said cover layer is transparent.

11. A container according to claim 6, wherein said cover layer is opaque.

12. A method for manufacturing a dimensionally stable and impervious container having an external surface and an internal surface comprising a seal-bonded, full-surface external diffusion barrier layer, which is composed of film material, and a plastic support layer continuously forming said internal surface of said container comprising the steps of:
placing the film material forming the diffusion barrier layer in the form of a full surface in a molding die of a plastic molding apparatus,
loading the molding die with plastic in moldable, sealable condition and,
removing the container provided with the seal-bonded diffusion barrier layer from the molding die after solidification of the plastic.

13. A method according to claim 12, wherein said film material is covered on one side with an aluminum containing material and is loaded into the molding die with said aluminum covered side on the outside.

14. A method according to claim 12, wherein said molding die has joints and said film material is loaded into the molding die such that it overlaps at said joints.

15. A method according to claim 12, wherein it is performed with a molding die of a plastic injection-molding apparatus.

16. A method according to claim 12, wherein it is performed with a molding die of a plastic blow-molding apparatus.

17. A container according to claim 1, wherein said plastic is a non-polyethylene terephthalate containing plastic, that does not have any superior barrier effect against the diffusion of oxygen and/or carbon dioxide.

18. A container according to claim 2, wherein said plastic film is selected from the group consisting of polyethylene film, polyethylene film laminated with aluminum, polyethylene film laminated with an aluminum alloy, polypropylene film, polypropylene film laminated with aluminum and polypropylene film laminated with an aluminum alloy.

19. A container according to claim 5, wherein said aluminum containing material is selected from the group consisting of aluminum and an aluminum alloy.

20. A container according to claim 6, wherein said cover layer of plastic is a member selected from the group consisting of polyethylene and polypropylene.

21. A container according to claim 17, wherein said plastic is a member selected from the group consisting of polyethylene and polypropylene.
